(19) United States
(12) Patent Application Publication
(10) Pub. No.: US 2024/0044930 A1
(43) Pub. Date: Feb. 8, 2024

(54) NON-CONTACT DISPENSERS AND RELATED SYSTEMS AND METHODS

(71) Applicant: ILLUMINA, INC., San Diego, CA (US)

(72) Inventor: Xuance Zhou, Milpitas, CA (US)

(21) Appl. No.: 18/226,519

(22) Filed: Jul. 26, 2023

Related U.S. Application Data
(60) Provisional application No. 63/394,526, filed on Aug. 2, 2022.

(51) Int. Cl. G01N 35/10

(52) U.S. Cl. CPC G01N 35/1002; G01N 35/1016

(57) ABSTRACT

Non-contact dispensers and related systems and methods are disclosed. In accordance with an implementation, an apparatus includes a pump having a body that defines an inlet, an outlet, and a flow path fluidly coupling the inlet and the outlet. A first displacement member is movable from a first position to a second position within the flow path to urge a first volume of the fluid out of the outlet. A second displacement member is movable from a first position to a second position within the flow path to urge a second volume of the fluid out of the outlet.

### RELATED APPLICATION SECTION

This application claims the benefit of and priority to U.S. Provisional Patent Application No. 63/394,526, filed Aug. 2, 2022, the content of which is incorporated by reference herein in its entireties and for all purposes.

### BACKGROUND

DNA libraries may be prepared using work flows to allow samples to be sequenced. Contact dispensers such as pipettes are often used in such work flows.

### SUMMARY

Advantages of the prior art can be overcome and benefits as described later in this disclosure can be achieved through the provision of non-contact dispensers and related systems and methods. Various implementations of the apparatus and methods are described below, and the apparatus and methods, including and excluding the additional implementations enumerated below, in any combination (provided these combinations are not inconsistent), may overcome these shortcomings and achieve the benefits described herein.

In accordance with a first implementation, an apparatus includes a non-contact dispenser and a system. The non-contact dispenser has a body defining an inlet, an outlet, and a flow path fluidly coupling the inlet and the outlet and a valve to control flow out of the flow path. The system includes a receptacle to receive the non-contact dispenser, a first displacement member positionable within the flow path, and a second displacement member positionable within the flow path. The valve is actuatable to enable fluid to flow out of the flow path. The first displacement member is movable from a first position to a second position within the flow path to urge a first volume of the fluid out of the outlet and the second displacement member is movable from a first position to a second position within the flow path to urge a second volume of the fluid out of the outlet.

In accordance with a second implementation, an apparatus includes a non-contact dispenser. The non-contact dispenser includes a body, a pair of seals, and a valve. The body defines an inlet, an outlet, a first aperture, a second aperture, and a flow path coupling the inlet and the outlet. Each seal surrounds one of the first aperture or the second aperture. The valve is to control flow out of the flow path. The first aperture is to receive a first displacement member that is movable from a first position to a second position within the flow path to urge a first volume of fluid out of the outlet and the second aperture is to receive a second displacement member that is movable from a first position to a second position within the flow path to urge a second volume of the fluid out of the outlet.

In accordance with a third implementation, an apparatus includes a non-contact dispenser assembly. The non-contact dispenser assembly includes a body and a non-contact dispenser. The body defines a plurality of reservoirs. The non-contact dispenser includes a body and a valve. The body defines an inlet, an outlet, a first aperture, a second aperture, and a flow path fluidly coupling the reservoirs and the inlet and the outlet of the non-contact dispenser. The valve is to control flow out of the flow path. The first aperture is to receive a first displacement member that is movable from a first position to a second position within the flow path to urge a first volume of the fluid out of the outlet. The second aperture is to receive a second displacement member that is movable from a first position to a second position within the flow path to urge a second volume of the fluid out of the outlet.

In accordance with a fourth implementation, an apparatus includes a pump having a body that defines an inlet, an outlet, and a flow path fluidly coupling the inlet and the outlet. A first displacement member is movable from a first position to a second position within the flow path to urge a first volume of the fluid out of the outlet. A second displacement member is movable from a first position to a second position within the flow path to urge a second volume of the fluid out of the outlet.

In accordance with a fifth implementation, a method includes flowing a fluid through an inlet and into a flow path of a non-contact dispenser. The non-contact dispenser includes the inlet, an outlet, a first aperture, a second aperture, and the flow path fluidly coupling the inlet and the outlet. The method also includes positioning a first displacement member within the first aperture and positioning a second displacement member within the second aperture. The method also includes moving the first displacement member within the first aperture from a first position to a second position within the flow path to urge a first volume of the fluid out of the outlet.

In accordance with a sixth implementation, an apparatus includes a non-contact dispenser having a body, a valve, a first displacement member, and a second displacement member. The body defines an inlet, an outlet, a first aperture, a second aperture, and a flow path coupling the inlet and the outlet. The valve is to control flow out of the flow path. The first displacement member is positionable within the first aperture, and the second displacement member is positionable within the second aperture. The first displacement member is movable from a first position to a second position within the flow path to urge a first volume of fluid out of the outlet, and the second displacement member is movable from a first position to a second position within the flow path to urge a second volume of the fluid out of the outlet.

In accordance with a seventh implementation, a method includes flowing a fluid through an inlet and into a flow path of a body. The body includes the inlet, an outlet, a first aperture, a second aperture, and the flow path fluidly coupling the inlet and the outlet. The method also includes moving a first displacement member within the first aperture from a first position to a second position within the flow path to urge a first volume of the fluid out of the outlet and moving a second displacement member within the second aperture from a first position to a second position within the flow path to urge a second volume of the fluid out of the outlet.

In further accordance with the foregoing first, second, third, fourth, fifth, sixth, and/or seventh implementations, an apparatus and/or method may further comprise or include any one or more of the following:

In accordance with an implementation, the body defines a first aperture and a second aperture, and the first displacement member is positionable within the first aperture and the second displacement member is positionable within the second aperture.

In accordance with another implementation, the first aperture is coupled to the flow path and the second aperture is coupled to the flow path.

In accordance with another implementation, the apparatus also includes a pair of seals. Each seal surrounding one of the first aperture or the second aperture.

In accordance with another implementation, the pair of seals is over molded to the body.

In accordance with another implementation, the system includes a clamping plate positionable to compress the first seal and the second seal and urge the seals into sealing engagement with the corresponding first displacement member or the second displacement member.

In accordance with another implementation, the clamping plate includes a pair of apertures through which the corresponding first displacement member and the second displacement member pass.

In accordance with another implementation, the apparatus includes an actuator to actuate at least one of the first displacement member or the second displacement member between the first position and the second position.

In accordance with another implementation, the actuator includes a solenoid actuator or a piezoelectric actuator.

In accordance with another implementation, the valve includes a check valve.

In accordance with another implementation, either of the first displacement member or the second displacement member being in the second position enables a pressure of the fluid within the flow path to satisfy a cracking pressure of the check valve.

In accordance with another implementation, the apparatus includes a second valve to control flow into the inlet and the flow path.

In accordance with another implementation, the first valve includes a first check valve and the second valve includes a second check valve.

In accordance with another implementation, the check valve has a first cracking pressure and the second check valve has a second cracking pressure.

In accordance with another implementation, the first cracking pressure is greater than the second cracking pressure.

In accordance with another implementation, the apparatus includes a nozzle coupled to the outlet of the non-contact dispenser.

In accordance with another implementation, the first displacement member has a first cross-section and the second displacement member has a second cross-section.

In accordance with another implementation, the first volume is between about 1 μL and about 13 μL and the second volume is between about 1 μL and about 13 μL.

In accordance with another implementation, the first displacement member and the second displacement member are disposable.

In accordance with another implementation, the body includes a first portion and a second portion. The first portion having a first inner tapered surface defining the first aperture and a second inner tapered surface defining the second aperture.

In accordance with another implementation, the body has a first end and a second end. The inlet is positioned adjacent the first end and the outlet is positioned adjacent the second end.

In accordance with another implementation, the body has a wall having an inner surface that defines the flow path and the inner surface is contoured.

In accordance with another implementation, the apparatus includes the first displacement member and the second displacement member.

In accordance with another implementation, the reagent cartridge includes a manifold assembly including an outlet, a common fluidic line, a plurality of reagent fluidic lines, and a plurality of membrane valves. The common fluidic line is fluidly coupled to the outlet. The plurality of reagent fluidic lines are coupled to the corresponding outlet of the reservoirs. The plurality of membrane valves are selectively fluidly coupling the common fluidic line and a corresponding one of the plurality of reagent fluidic lines.

In accordance with another implementation, the reagent cartridge includes opposing membranes coupled to the body thereof. The body defines a portion of the common fluidic line, a portion of the plurality of reagent fluidic lines, and a plurality of valve seats that each separate the common fluidic line and a corresponding one of the plurality of reagent fluidic lines.

In accordance with another implementation, each of the reservoirs includes a distal end. The apparatus also includes a cover covering the distal ends of the reservoirs.

In accordance with another implementation, the cover includes an impermeable barrier.

In accordance with another implementation, the impermeable barrier includes foil.

In accordance with another implementation, the apparatus includes the first displacement member and the second displacement member.

In accordance with another implementation, the apparatus includes a system including the first displacement member and the second displacement member.

In accordance with another implementation, the pump includes a consumable.

In accordance with another implementation, the method includes prior to flowing the fluid through the inlet, compressing a pair of seals using a clamping plate and urging the seals into sealing engagement with the corresponding first displacement member or the second displacement member. Each seal surrounding one of the first aperture or the second aperture.

In accordance with another implementation, the method includes moving the first displacement member from the second position to the first position and flowing additional fluid through the inlet and into the flow path of the non-contact dispenser.

In accordance with another implementation, the method includes moving a second displacement member within the second aperture from a first position to a second position within the flow path to urge a second volume of the fluid out of the outlet.

In accordance with another implementation, the apparatus includes a pair of seals, each seal surrounding one of the first aperture or the second aperture.

In accordance with another implementation, the apparatus includes a first spring and a second spring carried by the non-contact dispenser. The first spring is to bias the first displacement member to the first position and the second spring is to bias the second displacement member to the first position.

In accordance with another implementation, the first displacement member has a first distal end and a first spring seat positioned at the first distal end and the second displacement member has a second distal end and a second spring seat positioned at the second distal end.

In accordance with another implementation, the first spring is positioned between the body and the first spring seat and the second spring is positioned between the body and the second spring seat.

In accordance with another implementation, the non-contact dispenser includes a housing that surrounds the body and retains the first displacement member and the second displacement member within the housing.

In accordance with another implementation, the housing partially surrounds the body.

In accordance with another implementation, the housing defines apertures that allow access to the corresponding first displacement member and the second displacement member.

In accordance with another implementation, the apparatus includes a clamping plate positionable to compress the first seal and the second seal and urge the seals into sealing engagement with the corresponding first displacement member or the second displacement member.

In accordance with another implementation, the clamping plate has a pair of tabs that are engagable to move the clamping plate to compress the first seal and the second seal.

In accordance with another implementation, the non-contact dispenser includes a housing that surrounds the body and defines opposing openings and the tabs extend through the openings.

In accordance with another implementation, the opposing openings include open sides of the housing.

In accordance with another implementation, the method includes a pump including the body.

In accordance with another implementation, moving the first displacement member within the first aperture from the first position to the second position within the flow path to urge the first volume of the fluid out of the outlet includes urging the first volume of the fluid toward a flow cell, the body being coupled to the flow cell.

In accordance with another implementation, the method includes urging the first displacement member from the second position toward the first position.

In accordance with another implementation, urging the first displacement member from the second position to the first position comprises using a spring.

In accordance with another implementation, the method includes prior to flowing the fluid through the inlet compressing a pair of seals using a clamping plate and urging the seals into sealing engagement with the corresponding first displacement member or the second displacement member. Each seal surrounding one of the first aperture or the second aperture.

In accordance with another implementation, the method includes a dispenser including the body.

In accordance with another implementation, the dispenser includes a non-contact dispenser.

It should be appreciated that all combinations of the foregoing concepts and additional concepts discussed in greater detail below (provided such concepts are not mutually inconsistent) are contemplated as being part of the subject matter disclosed herein and/or may be combined to achieve the particular benefits of a particular aspect. In particular, all combinations of claimed subject matter appearing at the end of this disclosure are contemplated as being part of the subject matter disclosed herein.

### BRIEF DESCRIPTION OF THE DRAWINGS

FIG. 1 illustrates a schematic diagram of an implementation of a system in accordance with the teachings of this disclosure.

FIG. 2 is a cross-sectional view of an implementation of a dispenser and a portion of a system that can be used to implement the dispenser and the system of FIG. 1.

FIG. 3 is a bottom isometric view of the first portion of the dispenser of FIG. 2.

FIG. 4 is a top isometric view of the first portion of the dispenser of FIG. 2.

FIG. 5 is a top isometric view of the second portion of the dispenser of FIG. 2.

FIG. 6 is an isometric view of the dispenser and the portion of the system of FIG. 2.

FIG. 7 is a cross-sectional view of an implementation of a dispenser that can be used to implement the dispenser of FIG. 1.

FIG. 8 is an isometric view of the dispenser of FIG. 7.

FIG. 9 illustrates a schematic diagram of an implementation of a system in accordance with the teachings of this disclosure.

FIG. 10 is a top plan view of a dispenser assembly that can be used to implement the dispenser assembly of FIG. 9.

FIG. 11 is a cross-sectional view of an implementation of a pump and a portion of a system.

### DETAILED DESCRIPTION

Although the following text discloses a detailed description of implementations of methods, apparatuses and/or articles of manufacture, it should be understood that the legal scope of the property right is defined by the words of the claims set forth at the end of this patent. Accordingly, the following detailed description is to be construed as examples only and does not describe every possible implementation, as describing every possible implementation would be impractical, if not impossible. Numerous alternative implementations could be implemented, using either current technology or technology developed after the filing date of this patent. It is envisioned that such alternative implementations would still fall within the scope of the claims.

At least one aspect of this disclosure is related to systems that automate library preparation processes, sample preparation processes, or other similar processes, and use less consumables, thereby reducing a footprint of the system and an amount of solid waste produced. The systems disclosed use a non-contact dispenser(s) that has an inline and a relatively straight fluid path that reduces the presence of corners, allows the non-contact dispensers to be easily flushed, and/or reduces manufacturing complexity. The non-contact dispensers can switch between dispensing different reagents as a result using the same non-contact dispenser without those reagents adversely interacting with one another. Dead volume of reagent is also reduced using the disclosed implementations.

The non-contact dispensers disclosed may include a body and a valve. The body defines an inlet, an outlet, a first aperture, a second aperture, and a flow path that fluidly couples the inlet and the outlet. The valve controls flow out of the flow path. The non-contact dispensers may be part of or fluidly coupled to a reagent reservoir containing fluid (e.g., reagent) to enable the non-contact dispenser to receive fluid for dispensing.

A system may have a receptacle to receive the non-contact dispenser, a first displacement member positionable within the first aperture and a second displacement member positionable within the second aperture. The first displacement member and the second displacement member may be part of the system and, thus, cleaned between procedures in some implementations. The first displacement member and the second displacement member may alternatively be disposables or may be part of the non-contact dispenser itself or an associated reagent cartridge.

The first displacement member is movable from a first position to a second position within the flow path in operation to urge a first volume of the fluid out of the outlet and the second displacement member is movable from a first position to a second position within the flow path to urge a second volume of the fluid out of the outlet. The first position may be a retracted position and the second position may be an extended position. The first displacement member and the second displacement member can thus be selectively actuated to cause the non-contact dispenser to dispense different volumes of fluid.

The flow path may be refilled with fluid after fluid is dispensed from the non-contact dispenser. The flow path may be filled with the fluid by moving the first displacement member and/or the second displacement member from the second position to the first position, thereby drawing the fluid into the flow path. The displacement members moving from the second position to the first position may create a negative pressure that draws the fluid into the flow path of the non-contact dispenser. The flow path may additionally or alternatively be filled with the fluid by flowing the fluid into the flow path using positive pressure.

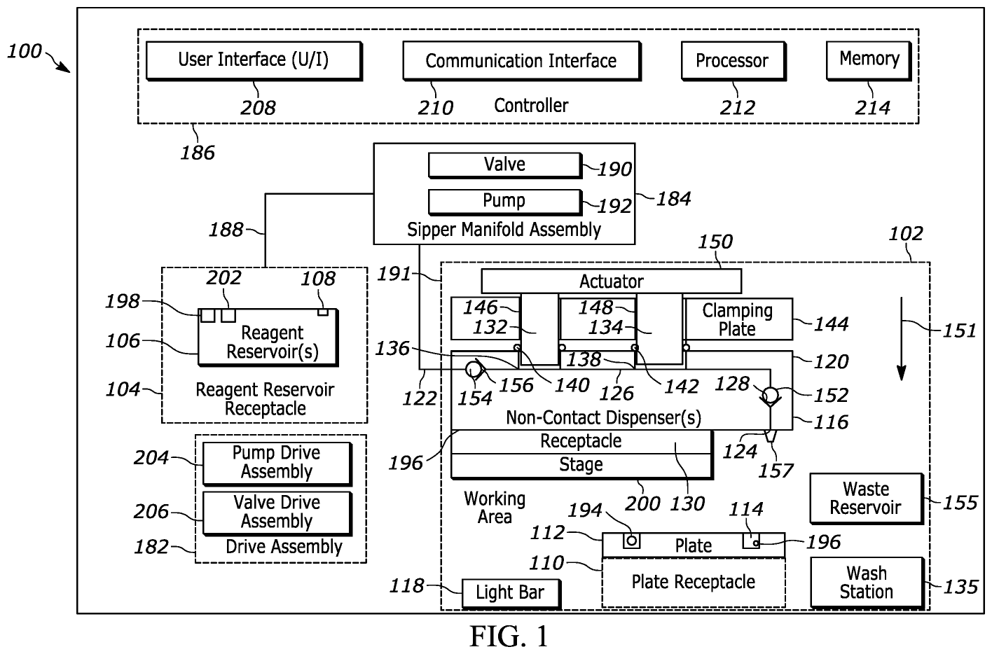

FIG. 1 illustrates a schematic diagram of an implementation of a system 100 in accordance with the teachings of this disclosure. The system 100 may be used to automatically, easily, and efficiently prepare DNA libraries for sequencing applications, for example. The system 100 may perform DNA library preparation workflows that include amplification processes, cleanup processes, library normalization processes, and/or pooling processes in some implementations. The system 100 may perform workflows such as whole genome sequencing (WGS) workflows, DNA & RNA enrichment workflows, methylation workflows, split-pool amplicon workflows, and/or amplicon workflows, among others. The DNA library preparation workflow can be performed on any number of samples such as between one sample and twenty-four samples, forty-eight samples, ninety-six samples, or more. The system 100 thus allows for variable batch processing. Other uses of the system 100 may prove suitable, however.

The system 100 includes a working area 102 and a reagent reservoir receptacle 104 to receive a reagent reservoir 106 in the implementation shown. In one implementation, the reagent reservoir 106 contains fluid 108. The fluid 108 may be reagent. The reagent reservoir receptacle 104 may alternatively be positioned above or below the working area 102.

The working area 102 includes a plate receptacle 110 that receives a plate 112 having a well 114 and a dispenser 116 that dispenses the fluid 108 from the reagent reservoir 106 into the well 114 of the plate 112. The dispenser 116 may be a non-contact dispenser as shown or a contact dispenser. The dispenser 116 may be referred to as a pump. The plate 112 may have any number of wells 114 such as twenty-four, forty-eight, or ninety-six wells. Another number of wells 114 is suitable, however.

The dispenser 116 is fluidly coupled to the reagent reservoir 106. The dispenser 116 may alternatively aspirate fluid 108 from the reagent reservoir 106 using tips, for example, and dispense the fluid 108 into the wells 114 of the plate 112. The dispenser 116 may be a contact dispenser when the dispenser 116 aspirates the fluid 108 from the reagent reservoir 106. The dispenser 116 may not be fluidly coupled to the reagent reservoir 106 in such implementations. The working area 102 may also include a light bar 118 that may be used to degrade oligonucleotides. The light bar 118 may be a high power ultraviolet light (UV) light bar that is regularly used throughout a workflow to repeatedly degrade oligonucleotides to deter cross contamination in some implementations.

The dispenser 116 includes a body 120 defining an inlet 122, an outlet 124, and a flow path 126 fluidly coupling the inlet 122 and the outlet 124 in the implementation shown. The dispenser 116 also has a valve 128 to control flow out of the flow path 126. The dispenser 116 may be a consumable and, thus, may be disposable. The valve 128 may be actuated to an open position to allow the dispenser 116 to aspirate fluid 108 from the reagent reservoir 106 using tips in such implementations as an example.

The system 100 has a receptacle 130 that receives the dispenser 116, a first displacement member 132, and a second displacement member 134. In one implementation, the displacement members 132, 134 may be cylindrical shaped rods having tolerances that allow desired volumes of liquid to be dispensed when actuated as described herein. The displacement members 132, 134 may take forms such as cylinders, cubes, spheres and hemispheres and/or may not have a specific shape but defines a volume that allow desired volumes of liquid to be dispensed when actuated as described herein, for example. The displacement members 132, 134 may have similar or different cross-sections and that cross-section may be a circular cross-section, an oblong cross-section, a rectangular cross-section, or a polygonal cross-section, as examples.

The first displacement member 132 is shown proximate the flow path 126 and the second displacement member 134 is shown proximate the flow path 126. The first displacement member 132 and the second displacement member 134 may be part of the system 100 and, thus, reusable. The system 100 may include a wash station 135 that can be used to clean and/or rinse the displacement members 132, 134 between interfacing with different dispensers 116 to deter against reagent-to-reagent cross contamination, for example. The wash station 165 may alternatively be omitted. The displacement members 132, 134 may alternatively be disposable.

The valve 128 is actuated in operation to enable fluid 108 to flow out of the flow path 126. In operation, the flow path 126 defines a volume that is filled with fluid 108 to define a filled volume of fluid. The first displacement member 132 is moved from a first position to a second position within the flow path 126 to urge a first volume of the fluid 108 out of the flow path 126 via the outlet 124 and the second displacement member 134 is moved from a first position to a second position within the flow path 126 to urge a second volume of the fluid out of the flow path 126 via the outlet 124. The first position may be a retracted position and the second position may be an extended position.

The body 120 of the dispenser 116 defines a first aperture 136 and a second aperture 138. The first displacement member 132 is positioned within the first aperture 136 and the second displacement member 134 is positioned within the second aperture 138. The first aperture 136 is coupled to the flow path 126 and the second aperture 138 is coupled to the flow path 126. The coupling between the first aperture 136, the second aperture 138, and the flow path 126 allows the first displacement member 132 and the second displacement member 134 to be positioned within the flow path 126.

The dispenser 116 also includes a pair of seals 140, 142 that surround the corresponding apertures 136, 138. The seals 140, 142 may be gaskets and/or O-rings. The seals 140, 142 may be over molded to the body 120. The seals 140, 142 may be carried by the dispenser 116 in different ways, however. The dispenser 116 may define seal grooves that receive the seals 140, 142 as an alternative example.

The system 100 also includes a clamping plate 144 in the implementation shown. The clamping plate 144 is positioned to compress the first seal 140 and the second seal 142 and urge the seals 140, 142 into sealing engagement with the first displacement member 132 or the second displacement member 134. The clamping plate 144 also reduces backlash of the seals 140, 142. The clamping plate 144 has a pair of apertures 146, 148 through which the corresponding first displacement member 132 and the second displacement member 134 pass.

The system 100 also includes an actuator 150 that is used to actuate the first displacement member 132 and/or the second displacement member 134 between the first position and the second position. The actuator 150 or another actuator may move the clamping plate 144 to compress the seals 140, 142. The actuator 150 movement may be relatively precise such as having a tolerance of ±3 μm.

The dispenser 116 may be positioned within the receptacle 130 and the system 100 may cause the actuator 150 to move the displacement members 132, 134 in the direction generally indicated by arrow 151 into the apertures 136, 138 of the dispenser 116. The system 100 may also cause the clamping plate 144 to move toward and into engagement with the seals 140, 142, compressing the seals 140, 142 into engagement with the corresponding displacement members 132, 134. The actuator 150 may have a solenoid for each of the displacement members 132, 134 in some implementations. The actuator 150 may be implemented by a solenoid actuator or a piezoelectric actuator. The actuator 150 may be implemented by different types of actuators, however.

The displacement members 132 and/or 134 can be moved in the direction generally indicated by the arrow 151 and into the second position within the flow path 126 to dispense the fluid 108 from the dispenser 116 and into one of the wells 114 of the plate 112. The valve 128 controls the flow of the fluid 108 out of the outlet 124 and may be a check valve 152. The first displacement member 132 and/or the second displacement member 134 being in the second position enables a pressure of the fluid 108 within the flow path 126 to satisfy a cracking pressure of the check valve 152. The check valve 152 is opened when the cracking pressure is satisfied to allow the fluid 108 to flow out of the dispenser 116.

The dispenser 116 may also include a second valve 154 that controls flow into the inlet 122 and the flow path 126. The second valve 154 may alternatively be positioned upstream of the dispenser 116. The system 100 may include the second valve 154 in such implementations. The check valve 152 may be referred to as a first check valve 152. The second valve 154 may be a check valve 156 that may be referred to as a second check valve 156. The check valves 152, 156 may inhibit backflow. The first check valve 152 has a first cracking pressure and the second check valve 156 has a second cracking pressure in some implementations. The first cracking pressure is greater than the second cracking pressure.

The first displacement member 132 and/or the second displacement member 134 may move from the second position to the first position in operation to draw the fluid 108 toward the dispenser 116 and into the flow path 126, allowing the flow path 126 to fill with the fluid 108. The system 100 may additionally or alternatively flow the fluid 108 toward the dispenser 116 in operation and the second check valve 156 may open after the second cracking pressure is satisfied allowing the flow path 126 to fill with the fluid 108. The first displacement member 132 and/or the second displacement member 134 may additionally or alternatively open the second check valve 156 when the first displacement member 132 and/or the second displacement member 134 is retracted and moved away from the flow path 126. The fluid 108 may alternatively be flowed into the flow path 126 at a pressure that satisfies the cracking pressure of both of the valves 152, 156 and, thus, both of the valves 152, 156 may be in the open position as the flow path 126 is filled with the fluid 108. The valve 152, 156 being open allows air to vent out of the outlet 124 and/or for fluid within the flow path 126 to flow out of the outlet 124 as the flow path 126 is filled with the fluid 108.

The system 100 includes a waste reservoir 155 in the implementation shown and the dispenser 116 may dispense/spit the fluid into the waste reservoir 155 as the flow path 126 is filled with the fluid 108 as an example. The waste reservoir 155 may alternatively be omitted. The system 100 may stop flowing the fluid 108 into the flow path 126 after the flow path 126 is filed with the fluid 108 and/or after the system 100 determines that air and/or another fluid (e.g., wash buffer) is no longer in the flow path 126.

The actuator 150 may move the first displacement member 132 and/or the second displacement members 134 into the flow path 126 to increase the pressure within the flow path 126, allow the first cracking pressure of the first check valve 152 to be satisfied, and for the fluid 108 to flow out of a nozzle 157. The nozzle 157 is shown coupled to the outlet 124 of the dispenser 116. The nozzle 157 may be integral with the body 120 of the dispenser 116 or may be a separate component. The nozzle 157 may be made from a different material from the body 120 in some implementations. The nozzle 157 being a separate component may enable the nozzle 157 to have material properties that allows for lower surface tension and/or for threshold wall thicknesses and/or orifice diameters to be satisfied.

The first displacement member 132 is shown having a first cross-section and the second displacement member 134 is shown having a second cross-section. The displacement members 132, 134 may have a circular cross-section or another cross-section such as an oval cross-section or a polygonal cross-section. The first displacement member 132 having the first cross-section may allow for the first volume of the fluid 108 to be dispensed from the outlet 124 when the first displacement member 132 is in the second position and the second displacement member 134 having the second cross-section may allow for the second volume of the fluid 108 to be dispensed from the outlet 124 when the second displacement member 134 is in the second position. The first volume may be between about 1 μL and about 13 μL and the second volume may be between about 1 μL and about 13 μL. The first volume may be about 1 μL, about 2 μL, about 3 μL, and/or about 7 μL and/or the second volume may be about 1 μL, about 2 μL, about 3 μL, and/or about 7 μL as examples. Other volumes may be dispensed however. Further, the first displacement member 132 and the second displacement member 134 may be used in combination to dispense additional volumes. The first displacement member 132 and the second displacement member 134 may alternatively have the same or a substantially similar cross-section. The displacement members 132, 134 having the same cross-section may allow for the same volume of the fluid 108 to be dispensed from the outlet 124 when the first displacement member 132 is in the second position and/or when the second displacement member 134 is in the second position. The first displacement member 132 may dispense the first volume of the fluid 108 from the outlet 124 when the first displacement member 132 is in a partially extended position and the second displacement member 134 may dispense the second volume of the fluid 108 from the outlet 124 when the second displacement member 134 is in a fully extended position as another example.

The system 100 also includes a drive assembly 182, a sipper manifold assembly 184, and a controller 186. The sipper manifold assembly 184 may be coupled to a corresponding number of the reagent reservoirs 106 via reagent sippers 188. The reagent reservoir(s) 106 may contain the fluid 108 (e.g., reagent and/or another reaction component). The sipper manifold assembly 184 includes a plurality of ports in some implementations where each port of the sipper manifold assembly 184 may receive one of the reagent sippers 188. The reagent sippers 188 may be referred to as fluidic lines.

The sipper manifold assembly 184 also includes a valve 190 that may be selectively actuated to control the flow of fluid through a fluidic line 191. The fluidic line 191 fluidly couples the sipper manifold assembly 184 and the dispenser 116 in the implementation shown. The sipper manifold assembly 184 also includes a pump 192 to selectively flow the fluid 108 from the reagent reservoir 106, through the reagent sipper 188, through the fluidic line 191, and out of the dispenser 116.

The valve 190 may be implemented by a rotary valve, a pinch valve, a flat valve, a solenoid valve, a check valve, a piezo valve, etc. Other fluid control devices may prove suitable. The pump 192 may be implemented by a syringe pump, a peristaltic pump, and/or a diaphragm pump. Other types of fluid transfer devices may be used, however. The controller 186 is electrically and/or communicatively coupled to the dispenser 116, the sipper manifold assembly 184, the valve 190, the pump 192, and the drive assembly 182 to perform various functions as disclosed herein. The sipper manifold assembly 184 may alternatively be omitted.

Different wells 114 of the plate 112 may contain different samples 194. The samples 194 may be a biological sample derived from a human, animal, plant, bacteria, or fungi. Other sources of obtaining the biological samples may prove suitable. Beads 196 may be dispensed into the wells 114 and the dispenser 116 may be aligned with the plate 112 in operation. The dispenser 116 dispenses a first reagent 198 from the reagent reservoir 106 into the well 114 of the plate 112. The first reagent 198 may be a bead buffer and the sample 194 may bind to the beads 196 in the presence of the bead buffer.

The dispenser 116 may be able to jet dispense with adequate liquid velocity to enable jet mixing in some implementations. The dispenser 116 may jet dispense by moving the first and/or second displacement between the first and second positions to repeatedly draw the fluid 108 into the flow path 126 and dispense the fluid 108 out of the outlet 124. The dispenser 116 may also deliver larger volumes of the fluid 108 by flowing the fluid 108 into the dispenser 116 at a pressure that satisfies the cracking pressure of both the first and second check valves 152, 156. In one implementation, the check valves 152, 156 can be opened mechanically without fluid flow. In this implementation, larger volumes of the fluid 108 can flow through the dispenser 116 at pressures below the cracking pressure of both the first and second check valves 152, 156. The valves 128, 154 may be implemented by a different type of valve that is actuated by an actuator between a closed position and an open position to allow the fluid 108 to flow through the flow path 126 including larger volumes of the fluid 108. The valves 128, 154 may be implemented by a pinch valve, a flat valve, a solenoid valve, a piezo valve, etc. The valves 128, 154 may be implemented by different types of fluid control devices, however.

A stage 200 may be coupled to and adapted to move the dispenser 116 to allow the dispenser 116 to dispense liquid such as the first reagent 198 into the well 114 of the plate 112. The stage 200 may be a z-stage or an x-y-x stage in some implementations. The stage 200 may be an x-y-z stage in implementations when the dispenser 116 is positioned to aspirate the fluid 108 directly from the reagent reservoir 106, for example. The well 114 may also be on a stage to facilitate positioning of the well 114 relative to the dispenser 116. The stage 200 may alternatively be omitted.

The dispenser 116 may be aligned with the plate 112 after the first reagent 198 is removed and the dispenser 116 dispenses a second reagent 202 from the reagent reservoir 106 into the well 114 of the plate 112. The second reagent 202 may be an elution buffer that releases the sample 194 from being bound to the beads 196 and, specifically, releases DNA associated with the sample 194 from being bound to the beads 196. The dispenser 116 may be used to perform additional or different portions of a workflow(s), however.

The drive assembly 182 includes a pump drive assembly 204 and a valve drive assembly 206. The pump drive assembly 204 may be adapted to interface with the pump 192 to pump fluid from the reagent reservoir 106 to the dispenser 116. The valve drive assembly 206 may be adapted to interface with the valve 190 to control the position of the valve 190.

The controller 186 includes a user interface 208, a communication interface 210, one or more processors 212, and a memory 214 storing instructions executable by the one or more processors 212 to perform various functions including the disclosed implementations. The user interface 208, the communication interface 210, and the memory 214 are electrically and/or communicatively coupled to the one or more processors 212.

In an implementation, the user interface 208 receives input from a user and provides information to the user associated with the operation of the system 100 and/or an analysis taking place. The user interface 208 may include a touch screen, a display, a key board, a speaker(s), a mouse, a track ball, and/or a voice recognition system. The touch screen and/or the display may display a graphical user interface (GUI).

In an implementation, the communication interface 210 enables communication between the system 100 and a remote system(s) (e.g., computers) using a network(s). The network(s) may include an intranet, a local-area network (LAN), a wide-area network (WAN), the intranet, etc. Some of the communications provided to the remote system may be associated with an amplification process(es), a cleanup process(es), a library normalization process(es), and/or a pooling process(es)), etc. generated or otherwise obtained by the system 100. Some of the communications provided to the system 100 may be associated with an amplification process(es), a cleanup process(es), a library normalization process(es), and/or a pooling process(es) to be executed by the system 100.

The one or more processors 212 and/or the system 100 may include one or more of a processor-based system(s) or a microprocessor-based system(s). In some implementations, the one or more processors 212 and/or the system 100 includes a reduced-instruction set computer(s) (RISC), an application specific integrated circuit(s) (ASICs), a field programable gate array(s) (FPGAs), a field programable logic device(s) (FPLD(s)), a logic circuit(s), and/or another logic-based device executing various functions including the ones described herein.

The memory 214 can include one or more of a hard disk drive, a flash memory, a read-only memory (ROM), erasable programable read-only memory (EPROM), electrically erasable programable read-only memory (EEPROM), a random-access memory (RAM), non-volatile RAM (NVRAM) memory, a compact disk (CD), a digital versatile disk (DVD), a cache, and/or any other storage device or storage disk in which information is stored for any duration (e.g., permanently, temporarily, for extended periods of time, for buffering, for caching).

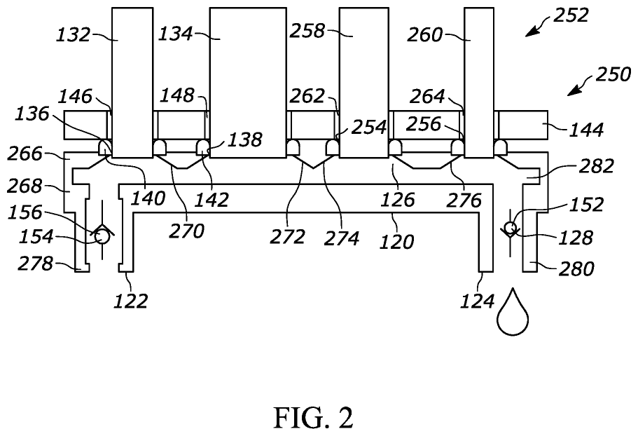

FIG. 2 is a cross-sectional view of an implementation of a dispenser 250 and a portion of a system 252 that can be used to implement the dispenser 116 and the system 100 of FIG. 1. The dispenser 250 may be a non-contact dispenser as shown or a contact dispenser. The dispenser 250 of FIG. 2 includes the body 120 defining the inlet 122, the outlet 124, a plurality of apertures 136, 138, 254, 256, and the flow path 126 coupling the inlet 122 and the outlet 124. The system 252 includes a plurality of displacement members 132, 134, 258, 260 and the clamping plate 144 defining a plurality of apertures 146, 148, 262, 264. The dispenser 250 may include any number of the apertures 133, 138, 254, 256 and the system 252 may have a corresponding number of the displacement members 132, 134, 258, 260 to allow different volumes of the fluid 108 to be dispensed. The apertures 136, 138, 254, 256 are sized to accommodate the different sized displacement members 132,134, 258, 260. The apertures 136, 138, 254, 256 and the displacement members 132,134, 258, 260 may thus have corresponding sizes.

In operation, the flow path 126 is filled with a volume of fluid 108. The displacement members 132, 134, 258, 260 are movable within the corresponding apertures 136, 138, 254, 256, 146, 148, 262, 264 between a first position shown in FIG. 2 and a second position within the flow path 126 to urge a volume of the fluid 108 out of the outlet 124. More than one of the displacement members 132, 134, 258, 260 can be moved to the second position at the same time to dispense a larger volume of the fluid 108. The dispenser 250 may dispense about 9 μL if the first and second displacement members 132, 134 are both moved to the second position and the dispenser 250 may dispense about 12 μL if the first, second, and third displacement members 132, 134, 258 are moved to the second position as examples. The dispenser 250 may dispense different amounts of the fluid 108, however.

The body 120 of the dispenser 250 has a first portion 266 and a second portion 268. The first and second portions 266, 268 may be coupled by ultrasonic welding. The first and second portions 266, 268 may include plastic. The first and second portions 266, 268 may be coupled in different ways and/or be made from different materials, however. The first portion 266 of the body 120 has a first inner tapered surface 270 defining the first aperture 136 and a second inner tapered surface 272 defining the second aperture 138. The first portion 266 of the body 120 also has inner tapered surfaces 274, 276 that define the third and fourth apertures 254, 256. The dispenser 250 may include the inner tapered surfaces 270, 272, 274, 276 to facilitate flushing the flow path 126 with a wash buffer as an example. The body 120 has a first end 278 and a second end 280 in the implementation shown, where the inlet 122 is positioned adjacent the first end 278 and the outlet 124 positioned adjacent the second end 280.

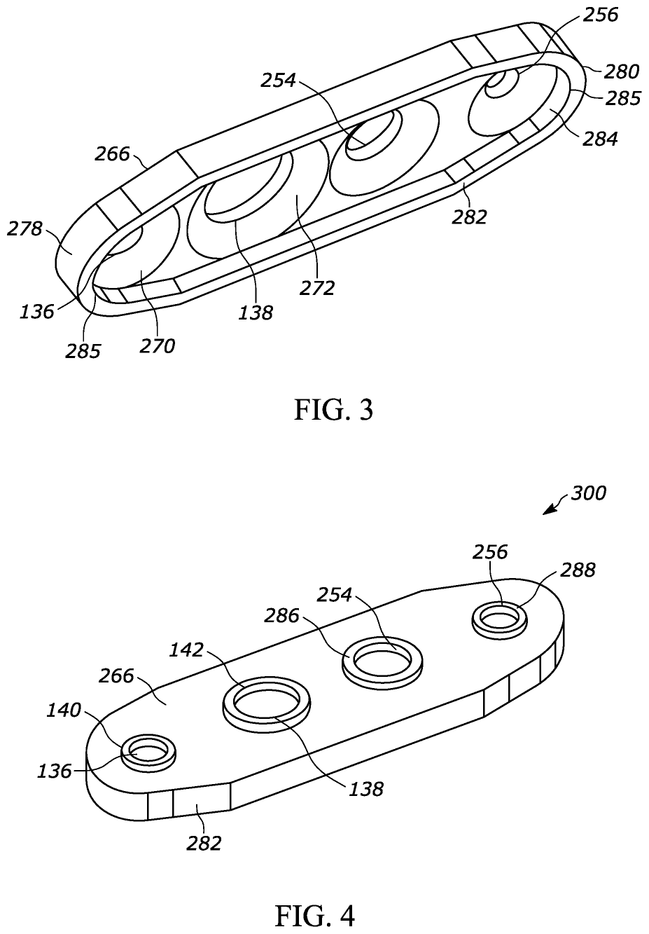

FIG. 3 is a bottom isometric view of the first portion 266 of the dispenser 250 of FIG. 2. The body 120 has a wall 282 having an inner surface 284 that defines the flow path 126. The inner surface 284 is contoured. The inner surface 284 has curved portions 285 at the ends 278, 280. The inner surface 284 may be contoured to facilitate flushing the flow path 126, for example.

FIG. 4 is a top isometric view of the first portion 266 of the dispenser 250 of FIG. 2. The first portion 266 includes seals 140, 142, 286, 288 that surround the corresponding apertures 136, 138, 254, 256 and are shown over molded to the first portion 266 of the dispenser 250.

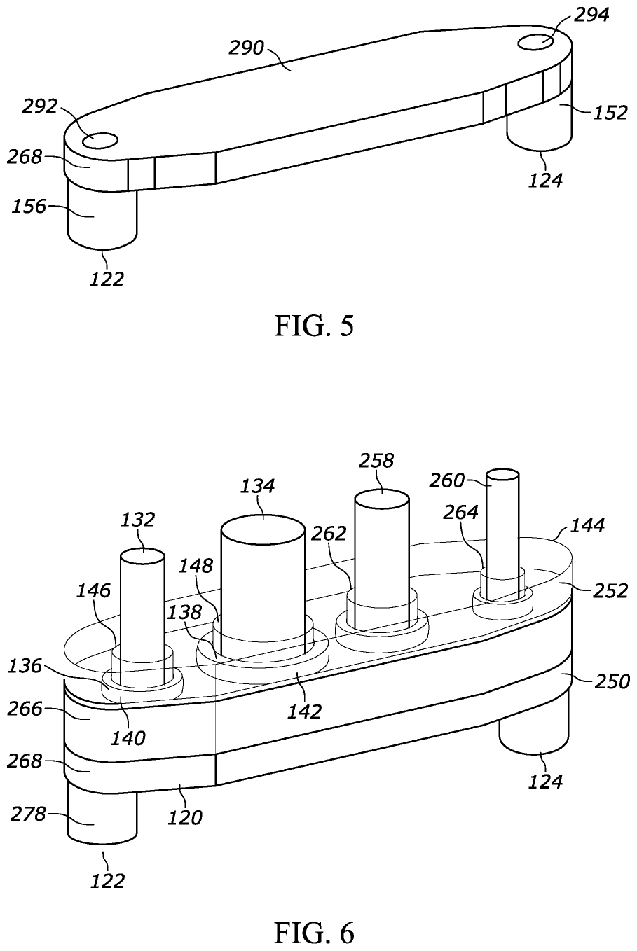

FIG. 5 is a top isometric view of the second portion 268 of the dispenser 250 of FIG. 2. The second portion 268 carries the check valves 152, 156 in the implementation shown and has a surface 290 that defines a portion of the flow path 126. The surface 290 also defines an aperture 292 that is fluidly coupled to the inlet 122 and an aperture 294 that is fluidly coupled to the outlet 124.

FIG. 6 is an isometric view of the dispenser 250 and the portion of the system 252 of FIG. 2. The dispenser 250 includes the first and second portions 266, 268 and the system 252 includes the displacement members 132, 134, 258, 260 and the clamping plate 144 defining the apertures 146, 148, 262, 264.

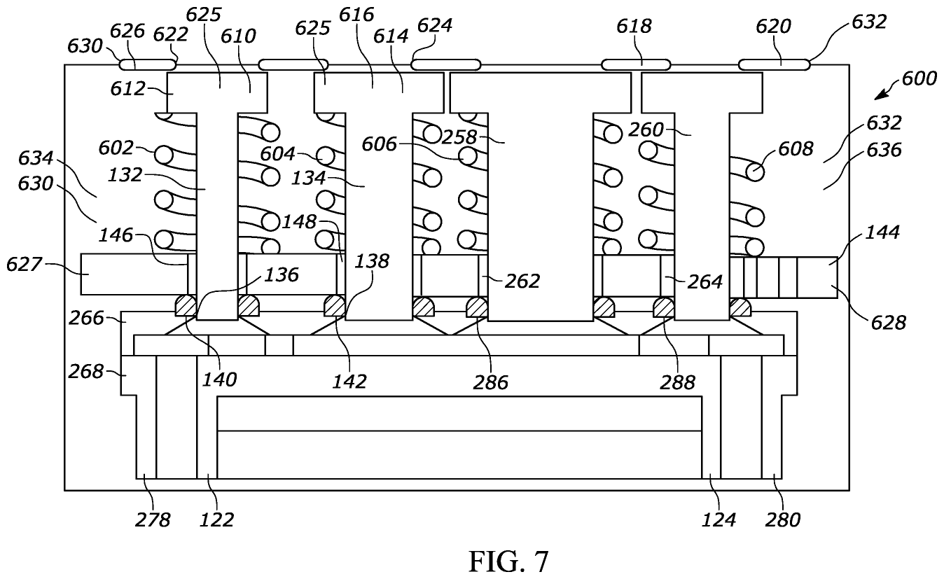

FIG. 7 is a cross-sectional view of an implementation of a dispenser 600 that can be used to implement the dispenser 116 of FIG. 1. The dispenser 600 may be a non-contact dispenser as shown or a contact dispenser. The dispenser 600 of FIG. 7 is similar to the dispenser 250 of FIG. 2. The dispenser 600 of FIG. 7 includes the first displacement member 132 positioned within the first aperture 136 and the second displacement member 134 positioned within the second aperture 138, however. The dispenser 600 thus carries the first and second displacement members 132, 134 and the displacement members 132,134 are not part of the system 100 in the implementation shown.

The dispenser 600 includes a first spring 602 and a second spring 604 carried by the dispenser 600. The first spring 602 biases the first displacement member 132 to the first position and the second spring 604 biases the second displacement member 134 to the first position. The dispenser 600 also includes springs 606, 608 that bias the other displacement members 258, 260. The springs 602, 604, 606, 608 are shown as coil springs but any type of biasing element may be used. The springs 602,604, 606, 608 may be implemented by belleville washers as an example.

The first displacement member 132 has a first distal end 610 and a first spring seat 612 positioned at the first distal end 610 and the second displacement member 134 has a second distal end 614 and a second spring seat 616 positioned at the second distal end 614. The first spring 602 is positioned between the body 120 and the first spring seat 612 and the second spring 604 is positioned between the body 120 and the second spring 616.

The system 100 may include displacement members that interface with the distal ends 610, 614 of the corresponding displacement members 132, 134 to move the displacement members 132, 134 from the first position shown to the second position within the flow path 126 and urge a volume of the fluid 108 out of the outlet 124. The springs 602, 604 return the displacement members 132, 134 to the first position.

The dispenser 600 has a housing 618 in the implementation shown that surrounds the body 120 of the dispenser 600 and retains the first displacement member 132 and the second displacement member 134 within the housing 618. The housing 618 may partially surround the body 120 as shown. The housing 618 defines apertures 622, 624 that allow access to the corresponding first displacement member 132 and the second displacement member 134. The housing 618 also defines apertures that allow access to the other displacement members 258, 260. The distal ends 610, 614 of the displacement members 132, 134 have an outer area 625 that engages an inner surface 626 of the housing 618 that surrounds the corresponding apertures 622, 624. The engagement between the outer area 625 and the inner surface 626 retains the first displacement member 132 and the second displacement member 134 within the housing 618.

The dispenser 600 also has a clamping plate 144 positioned to compress the first seal 140 and the second seal 142 and urge the seals 140, 142 into sealing engagement with the corresponding first displacement member 132 or the second displacement member 134. The clamping plate 144 is positioned between the body 120 and the springs 602, 604, 606, 608. The springs 602, 604, 606, 608 engage the clamping plate 144 in the implementation shown.

The clamping plate 144 has a pair of tabs 627, 628 that are engagable to move the clamping plate 144 to compress the first seal 140 and the second seal 142. The tabs 627, 628 extend from the ends 278, 280 of the body 120 to allow the system 100 to access the tabs 627, 628 and urge the clamping plate 144 to compress the seals 140, 142, 286, 288 for example. The housing 618 defines opposing openings 630, 632 in the implementation shown and the tabs 627, 628 extend through the openings 630, 632. The housing 618 may have open sides 634, 636 that define the openings 630, 632.

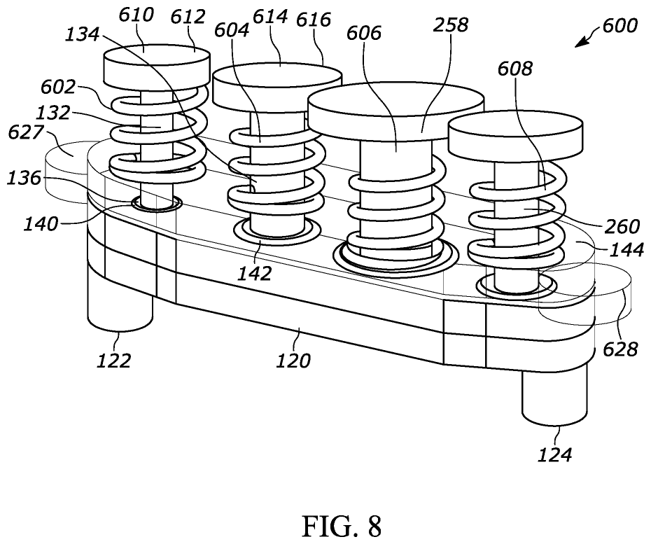

FIG. 8 is an isometric view of the dispenser 600 of FIG. 7. The dispenser 700 includes the displacement members 132, 134, 258, 260, the springs 602, 604, 606, 608, and the clamping plate 144 defining the apertures 146, 148, 262, 264.

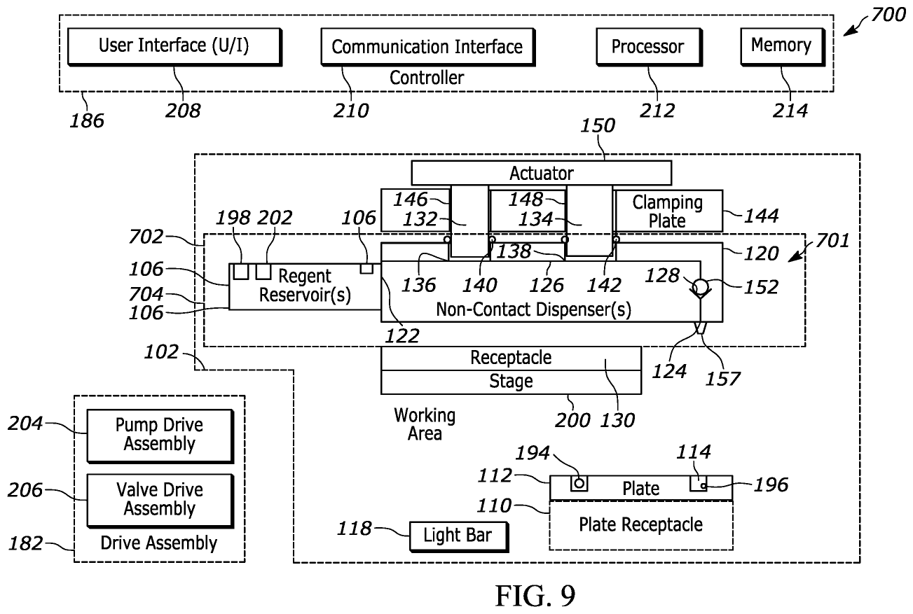

FIG. 9 illustrates a schematic diagram of an implementation of a system 700 in accordance with the teachings of this disclosure. The system 700 of FIG. 9 is similar to the system 100 of FIG. 1. The system 700 of FIG. 9 includes a dispenser assembly 701 including a regent cartridge 702 having a body 704 and the dispenser 116, however. The dispenser assembly 700 may be a non-contact dispenser assembly as shown or may flow the fluid 108 to another component such as a flow cell. The dispenser assembly 702 is received within the receptacle 130 in the implementation shown. The receptacle 130 of FIG. 9 may be referred to as a reagent cartridge receptacle and/or a dispenser assembly receptacle.

The body 704 of the reagent cartridge 702 defines the plurality of reservoirs 106 and the dispenser 116 includes the body 120 defining the inlet 122, the outlet 124, the first aperture 136, the second aperture 138, and the flow path 126. The flow path 126 fluidly couples the reservoirs 106, the inlet 122 and the outlet 124 of the dispenser 116. The first aperture 136 receives the first displacement member 132 and the second aperture 138 receives the second displacement member 134. Each of the displacement members 132, 134 is movable from a first position to a second position within the flow path 126 to urge a volume of the fluid 108 out of the outlet 124. The volume may be considered a first volume if the first displacement member 132 is moved to the second position, the volume may be a considered a second volume if the second displacement member 134 is moved to the second position, and the volume may be a considered a third volume if both the first and second displacement members 132, 134 are moved to the second position.

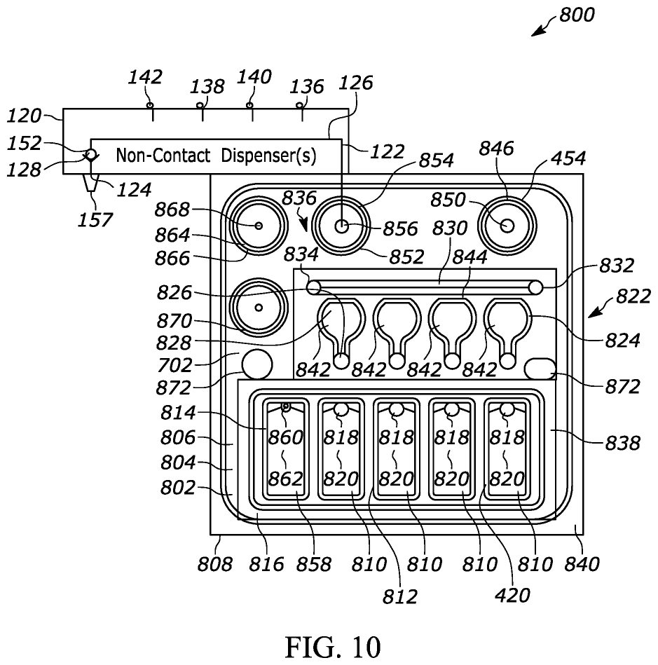

FIG. 10 is a top plan view of a dispenser assembly 800 that can be used to implement the dispenser assembly 701 of FIG. 9. The dispenser assembly 800 may be a non-contact dispenser assembly as shown or may flow the fluid 108 to another component such as a flow cell. The dispenser assembly 701 includes the reagent cartridge 702 and the dispenser 116.

The reagent cartridge 702 includes a body 802 having a base portion 804 with top and bottom surfaces 806, 808. The body 802 also includes a plurality of reservoirs 810 defined by walls 812 extending upwardly from the base portion 804 to distal ends 814 that define an open top. The reservoirs 810 may be referred to as reagent reservoirs. The reagent cartridge 702 can be provided with a cover 816 that extends over the open tops of the reservoirs 810 and seals to the distal ends 814 of the walls 812 to thereby seal each of the reservoirs 810 to safely contain reagents disposed therein for storage and transportation purposes. The cover 816 can be made of any suitable material, such as a foil, plastic, etc.

Each of the reservoirs 810 has an outlet 818 extending through the base portion 804 to open at the bottom surface 808 thereof. A bottom surface 820 of each of the reservoirs 810 can be angled or otherwise contoured to direct fluid flow to the outlet 818 thereof. For example, a reservoir 810 having a rectangular horizontal cross-section as shown can include a forwardly angled bottom surface 808 with a funneled front end to direct fluid flow to the outlet 818. The reservoirs 810 can have different volumes if desired although the reservoirs 810 of this implementation are shown with a common volume.

The reagent cartridge 702 includes a manifold assembly 822 that can be used to selectively dispense reagents stored within the reservoirs 810. The manifold assembly 822 also includes valve bodies 824 defined in the base portion 804 for each of the reservoirs 810 and reagent fluidic lines are defined in the bottom surface 808 of the base portion 804 to fluidly connect the outlet 818 of the reservoirs 810 to the respective valve body 824. The valve bodies 824 include an inlet opening 826 defined through the body base portion 804 that feeds into a cavity 828 defined in the body top surface 806 in the illustrated implementation.

A common fluidic line 830 for the manifold assembly 822 extends adjacent to the valve bodies 824. The common fluidic line 830 is defined in the top surface 806 of the body base portion 804 in the implementation shown and has a proximal end 832 and an opposite, distal end 834 fluidly connected to a cartridge outlet 836. The valve bodies 824 are disposed adjacent to the common fluidic line 830 between the proximal and distal ends 832, 834. The cavity 828 of the valve bodies 824 can have a paddle configuration, as shown, with a truncated circular distal end, where the truncated edge extends along the common fluidic line 830.

The reagent cartridge 702 also includes a top membrane 838 that is coupled to the top surface 806 of the body base portion 804 and a bottom membrane 840 that is coupled to the bottom surface 808 of the body base portion 804. The top and bottom membranes 838, 840 interact with the valve bodies 824 to form membrane valves 842 corresponding to each of the reservoirs 810. The top membrane 838 selectively engages a valve seat 844 defined by an edge of the cavity 828. The top membrane 838 extends over and seals the common fluidic line 830 and the bottom membrane 840 extends over and seals the reagent fluidic lines 436 and the inlet opening 826.

The body 802 further defines a cleaning port or reservoir 846 defined by walls 848 extending upwardly from the base portion 804. An outlet 850 of the cleaning port 846 extends into or through the body 802 and is fluidly connected to the proximal end 832 of the common fluidic line 830. The outlet 850 of the cleaning port 846 is connected to the common fluidic line 830 by a cleaning line defined in the body bottom surface 808 and sealed by the bottom membrane 840. The cleaning line can alternatively be defined in the body top surface 806 and sealed by the top membrane 838.

The cartridge outlet 836 includes an outlet port 852 defined by walls 854 extending upwardly from the base portion 804 in the implementation shown. The outlet port 852 is fluidly coupled to the inlet 122 of the dispenser 116 in the implementation shown. Fluid 108 that flows out of the outlet port 852 may be received by the inlet 122 of the dispenser 116 and be dispensed by the nozzle 157, for example.

An inlet opening 856 of the outlet port 852 extending into or through the body 802 is fluidly connected to the distal end 834 of the common fluidic line 830. In one implementation, the inlet opening 856 of the outlet port 852 can be connected to the common fluidic line 830 by an outlet line defined in the body bottom surface 808 and sealed by the bottom membrane 840. The outlet line could alternatively be defined in the body top surface 806 and sealed by the top membrane 838.

The body 802 further includes a secondary reservoir 858 defined by the walls 812 in some implementations that extend upwardly from the base portion 804 to the distal ends 814 that define an open top. As with the other reservoirs 810, the secondary reservoir 858 can be provided with the cover 816 that extends over the open tops of the reservoirs 810, 858 and seals to the distal ends 814 of the walls 812 to thereby seal each of the reservoirs 810, 858 to safely contain reagents disposed therein for storage and transportation purposes.

The reservoir 858 includes an outlet 860 extending through the base portion 804 to open at the bottom surface 808 thereof. A bottom surface 862 of the reservoir 858 can be angled or otherwise contoured to direct fluid flow to the outlet 860 thereof. The body 802 further defines a secondary port 864 defined by walls 866 extending upwardly from the base portion 804. An inlet opening 868 of the secondary port 864 extending into or through the body 802 is fluidly connected to the outlet 860 of the secondary reservoir 858. In one implementation, the outlet 860 of the secondary reservoir can be connected to the inlet opening 868 of the secondary port 864 by a secondary fluidic line defined in the body bottom surface 808 and sealed by the bottom membrane 840. The secondary fluidic line could alternatively be defined in the body top surface 806 and sealed by the top membrane 838. The reagent cartridge 702 also includes a secondary cleaning port 870 that is fluidly coupled to the secondary fluidic line.

The body base portion 804 can include a pair of locating holes 872 extending therethrough in order to easily mount the reagent cartridge 702 to the receptacle 130. The locating holes 872 can be located in any desired area of the base portion 804, including on either side as shown. If desired, one of the locating holes 872 can have an elongated or otherwise larger opening than a pin to be received therethrough to provide a user with clearance during an initial mounting of the reagent cartridge 702. One of the locating holes 872 is shown being oblong and the other of the locating holes 872 is shown being circular.

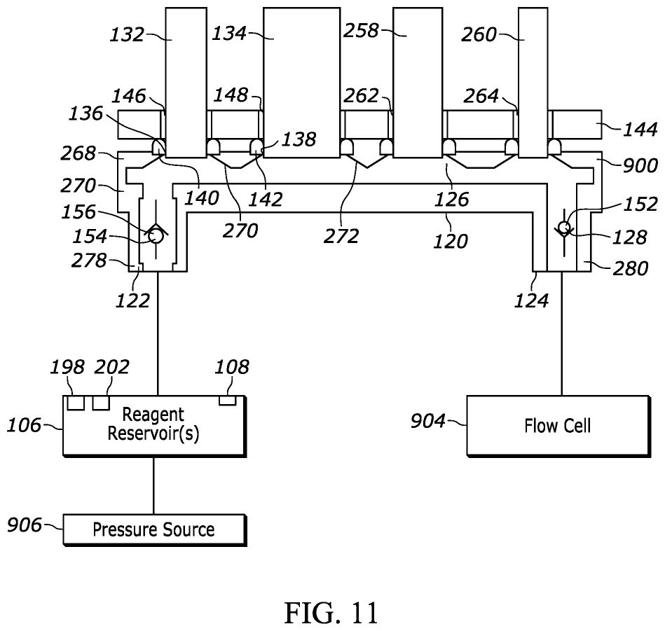

FIG. 11 is a cross-sectional view of an implementation of a pump 900 and a portion of a system 902. The pump 900 is similar to the dispenser 116 of FIG. 2. The outlet 124 of the pump 900 is coupled to a flow cell 904, however. As used herein, a “flow cell” can include a device having a lid extending over a reaction structure to form a flow channel therebetween that is in communication with a plurality of reaction sites of the reaction structure, and can include a detection device that detects designated reactions that occur at or proximate to the reaction sites.

The pump 900 may be coupled to other structures and not to the flow cell 904 in other implementations. The pump 900 may be a consumable in some implementations. The system 100 includes a pressure source 906 in the implementation shown that pressurizes the reagent reservoir 106 and urges the fluid 108 from the reagent reservoir 106 into the flow path 126 of the pump 900. The fluid 108 may be flowed into the flow path 126 of the pump 900 in different ways, however. A syringe pump may be used to flow the fluid 108 into the flow path 126 as an example and/or the displacement member 132 and/or 134 may be moved from the second position to the first position to draw the fluid 108 into the flow path 126.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

As used herein, an element or step recited in the singular and proceeded with the word “a” or “an” should be understood as not excluding plural of said elements or steps, unless such exclusion is explicitly stated. Furthermore, references to “one implementation” are not intended to be interpreted as excluding the existence of additional implementations that also incorporate the recited features. Moreover, unless explicitly stated to the contrary, implementations “comprising,” “including,” or “having” an element or a plurality of elements having a particular property may include additional elements whether or not they have that property. Moreover, the terms “comprising,” “including,” “having,” or the like are interchangeably used herein.

The terms “substantially,” “approximately,” and “about” used throughout this Specification are used to describe and account for small fluctuations, such as due to variations in processing. In certain implementations, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

There may be many other ways to implement the subject technology. Various functions and elements described herein may be partitioned differently from those shown without departing from the scope of the subject technology. Various modifications to these implementations may be readily apparent to those skilled in the art, and generic principles defined herein may be applied to other implementations. Thus, many changes and modifications may be made to the subject technology, by one having ordinary skill in the art, without departing from the scope of the subject technology. For instance, different numbers of a given module or unit may be employed, a different type or types of a given module or unit may be employed, a given module or unit may be added, or a given module or unit may be omitted.

Underlined and/or italicized headings and subheadings are used for convenience only, do not limit the subject technology, and are not referred to in connection with the interpretation of the description of the subject technology. All structural and functional equivalents to the elements of the various implementations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

1. An apparatus, comprising:
a non-contact dispenser, comprising:
a body defining an inlet, an outlet, and a flow path fluidly coupling the inlet and the outlet;
a valve to control flow out of the flow path;
a system, comprising:
a receptacle to receive the non-contact dispenser;
a first displacement member positionable within the flow path; and
a second displacement member positionable within the flow path,
wherein the valve is actuatable to enable fluid to flow out of the flow path, and the first displacement member is movable from a first position to a second position within the flow path to urge a first volume of the fluid out of the outlet and the second displacement member is movable from a first position to a second position within the flow path to urge a second volume of the fluid out of the outlet.

2. The apparatus of claim 1, wherein the body defines a first aperture and a second aperture, and the first displacement member is positionable within the first aperture and the second displacement member is positionable within the second aperture.

3. The apparatus of claim 2, wherein the first aperture is coupled to the flow path and the second aperture is coupled to the flow path.

4. The apparatus of claim 2, further comprising a pair of seals, each seal surrounding one of the first aperture or the second aperture.

5. The apparatus of claim 4, wherein the pair of seals is over molded to the body.

6. The apparatus of claim 4, wherein the system comprises a clamping plate positionable to compress the first seal and the second seal and urge the seals into sealing engagement with the corresponding first displacement member or the second displacement member.

7. The apparatus of claim 6, wherein the clamping plate comprises a pair of apertures through which the corresponding first displacement member and the second displacement member pass.

8. The apparatus of claim 1, further comprising an actuator to actuate at least one of the first displacement member or the second displacement member between the first position and the second position.

9. The apparatus of claim 8, wherein the actuator comprises a solenoid actuator or a piezoelectric actuator.

10. (canceled)

11. (canceled)

12. The apparatus of claim 1, further comprising a second valve to control flow into the inlet and the flow path.

13. The apparatus of claim 12, wherein the first valve comprises a first check valve and the second valve comprises a second check valve.

14. The apparatus of claim 13, wherein the check valve has a first cracking pressure and the second check valve has a second cracking pressure.

15. (canceled)

16. The apparatus of claim 1, further comprising a nozzle coupled to the outlet of the non-contact dispenser.

17. The apparatus of claim 1, wherein the first displacement member has a first cross-section and the second displacement member has a second cross-section.

18. (canceled)

19. (canceled)

20. An apparatus, comprising:
a non-contact dispenser, comprising:
a body defining an inlet, an outlet, a first aperture, a second aperture, and a flow path coupling the inlet and the outlet;
a pair of seals, each seal surrounding one of the first aperture or the second aperture; and
a valve to control flow out of the flow path,
wherein the first aperture is to receive a first displacement member that is movable from a first position to a second position within the flow path to urge a first volume of fluid out of the outlet, and the second aperture is to receive a second displacement member that is movable from a first position to a second position within the flow path to urge a second volume of the fluid out of the outlet.

21. The apparatus of claim 20, wherein the body comprises a first portion and a second portion, the first portion having a first inner tapered surface defining the first aperture and a second inner tapered surface defining the second aperture.

22. The apparatus of claim 20, wherein the body has a first end and a second end, the inlet positioned adjacent the first end and the outlet positioned adjacent the second end.

23. The apparatus of claim 20, wherein the body has a wall having an inner surface that defines the flow path and wherein the inner surface is contoured.

24. The apparatus of claim 20, further comprising the first displacement member and the second displacement member.

25. An apparatus, comprising:
a non-contact dispenser assembly, comprising:
a body defining a plurality of reservoirs; and
a non-contact dispenser, comprising:
a body defining an inlet, an outlet, a first aperture, a second aperture, and a flow path fluidly coupling the reservoirs, the inlet and the outlet of the non-contact dispenser; and
a valve to control flow out of the flow path,
wherein the first aperture is to receive a first displacement member that is movable from a first position to a second position within the flow path to urge a first volume of the fluid out of the outlet, and the second aperture is to receive a second displacement member that is movable from a first position to a second position within the flow path to urge a second volume of the fluid out of the outlet.

26. The apparatus of claim 25, wherein the reagent cartridge further comprises a manifold assembly, comprising:
an outlet;
a common fluidic line fluidly coupled to the outlet;
a plurality of reagent fluidic lines coupled to the corresponding outlet of the reservoirs; and
a plurality of membrane valves selectively fluidly coupling the common fluidic line and a corresponding one of the plurality of reagent fluidic lines

27. The apparatus of claim 26, wherein the reagent cartridge comprises opposing membranes coupled to the body thereof, the body defining a portion of the common fluidic line, a portion of the plurality of reagent fluidic lines, and a plurality of valve seats that each separate the common fluidic line and a corresponding one of the plurality of reagent fluidic lines.

28-38. (canceled)

39. An apparatus, comprising:
a non-contact dispenser, comprising:
a body defining an inlet, an outlet, a first aperture, a second aperture, and a flow path coupling the inlet and the outlet; and
a valve to control flow out of the flow path,
a first displacement member positionable within the first aperture; and
a second displacement member positionable within the second aperture,
wherein the first displacement member is movable from a first position to a second position within the flow path to urge a first volume of fluid out of the outlet, and the second displacement member is movable from a first position to a second position within the flow path to urge a second volume of the fluid out of the outlet.

(canceled)

41. The apparatus of claim 39, further comprising a first spring and a second spring carried by the non-contact dispenser, the first spring to bias the first displacement member to the first position and the second spring to bias the second displacement member to the first position.

42. (canceled)

43. (canceled)

44. The apparatus of claim 39, wherein the non-contact dispenser comprises a housing that surrounds the body and retains the first displacement member and the second displacement member within the housing.

45. (canceled)

46. (canceled)

47. The apparatus of claim 39, further comprising a pair of seals, each seal surrounding one of the first aperture or the second aperture, further comprising a clamping plate positionable to compress the first seal and the second seal and urge the seals into sealing engagement with the corresponding first displacement member or the second displacement member.

48-62. (canceled)
